(19) United States
(12) Patent Application Publication
(10) Pub. No.: US 2014/0073472 A1
(43) Pub. Date: Mar. 13, 2014

(54) FOUR-WHEEL DRIVE VEHICLE

(71) Applicants: Takahiro YOSHIMURA, Toyota-shi (JP); Hideki TAMOTO, Toyota-shi (JP); Masayuki HASHIMOTO, Toyota-shi (JP); Minoru ONITAKE, Kariya-shi (JP); Shun OHNO, Anjo-shi (JP)

(72) Inventors: Takahiro YOSHIMURA, Toyota-shi (JP); Hideki TAMOTO, Toyota-shi (JP); Masayuki HASHIMOTO, Toyota-shi (JP); Minoru ONITAKE, Kariya-shi (JP); Shun OHNO, Anjo-shi (JP)

(73) Assignee: TOYOTA JIDOSHA KABUSHIKI KAISHA, Toyota-shi (JP)

(21) Appl. No.: 14/024,322

(22) Filed: Sep. 11, 2013

(30) Foreign Application Priority Data
Sep. 13, 2012 (JP) 2012-201595

(51) Int. Cl. B60K 23/08

(52) U.S. Cl. CPC B60K 23/08
USPC 475/225

(57) ABSTRACT

A power transmitting shaft transmits power of a driving force source to driven wheels. A differential gear is connected to an axle of the driven wheels. A ring gear is provided between the power transmitting shaft and the differential gear. A switching mechanism between the driving force source and the power transmitting shaft switches between a four-wheel drive state and a two-wheel drive state. A two-way clutch is provided between the ring gear and the differential gear. The two-way clutch switches between a power transmitting state and a power transmission interrupted state.

### INCORPORATION BY REFERENCE

The disclosure of Japanese Patent Application No. 2012-201595 filed on Sep. 13, 2012 including the specification, drawings and abstract is incorporated herein by reference in its entirety.

### BACKGROUND OF THE INVENTION

1. Field of the Invention

The invention relates to a four-wheel drive vehicle capable of switching between two-wheel drive and four-wheel drive according to the running state of the vehicle.

2. Description of Related Art

Japanese Patent Application Publication No. 2011-255846 (JP 2011-255846 A) describes one such four-wheel drive vehicle that stops a propeller shaft from rotating by disengaging an engaging clutch provided on an input side of a propeller shaft, and releasing a connection of a torque coupling provided on an output side of the propeller shaft, in order to reduce drive loss due to the rotation of the propeller shaft when in two-wheel drive.

The torque coupling is provided on a drive shaft that couples rear wheels to a rear differential, and allows/interrupts the transmission of power between the rear wheels and the propeller shaft by adjusting the transfer torque.

### SUMMARY OF THE INVENTION

With the four-wheel drive vehicle described in JP 2011-255846 A, the torque coupling has a multiple disc clutch or an electromagnetic clutch and a cam mechanism or the like, so the entire apparatus ends up being an elaborate structure.

Two known apparatuses used to allow/interrupt the transmission of power (i.e., connect/disconnect power) are a so-called two-way clutch and a so-called one-way clutch. By using these clutches instead of a torque coupling, the overall apparatus is able to be more compact, and using a mechanical clutch also obviates the need for complex control.

However, when a two-way clutch is provided on a drive shaft, instead of a torque coupling, for example, the two-way clutch temporarily will shift into a power-transmission interrupted state as a result of a rotational difference between the drive shaft and the rear differential. At this time, rotating elements of the rear differential on the two-way clutch side will rotate in reverse with respect to the wheels because there is no longer any load. As a result, the two-way clutch will end up shifting back into a power-transmission allowed state, so the transmission of power between the rear wheels and the propeller shaft may not be able to be interrupted.

The invention thus provides a four-wheel drive vehicle capable of appropriately interrupting the transmission of power even when a structure that interrupts the transmission of power when in two-wheel drive is simple and compact.

One aspect of the invention relates to a four-wheel drive vehicle that includes a pair of main driving wheels, a pair of driven wheels, a power transmitting shaft, a differential gear, a ring gear, a switching mechanism, and a two-way clutch. The pair of main driving wheels are wheels to which power of a driving force source is transmitted. The pair of driven wheels are wheels to which power of the driving force source is transmitted according to a running state of the four-wheel drive vehicle. The power transmitting shaft is configured to transmit the power of the driving force source to the driven wheels. The differential gear is connected to an axle of the driven wheels. The ring gear is provided between the power transmitting shaft and the differential gear. The switching mechanism is configured to switch between a four-wheel drive state and a two-wheel drive state. In the four-wheel drive state, power is transmitted from the driving force source to the power transmitting shaft. In the two-wheel drive state, transmission of the power from the driving force source to the power transmitting shaft is interrupted. The two-way clutch is provided between the ring gear and the differential gear. The two-way clutch switches between a transmitting state and an interrupted state. In the transmitting state, power is transmitted between the power transmitting shaft and the driven wheels. In the interrupted state, transmission of the power between the power transmitting shaft and the driven wheels is interrupted.

According to this structure, in the four-wheel drive vehicle according to this aspect of the invention, a two-way clutch is provided as a connecting/disconnecting mechanism, so the structure for interrupting the transmission of power when in two-wheel drive is able to be simple and compact.

Also, in the four-wheel drive vehicle according to the aspect of the invention described above, the connecting/disconnecting mechanism is provided between the ring gear and the differential gear on the driven wheel side, so the transmission of power is able to be more appropriately interrupted, without reverse rotation being input to the two-way clutch from the differential gear when the transmission of power is interrupted, than it is when the two-way clutch is provided on the axle.

The invention thus makes it possible to provide a four-wheel drive vehicle capable of appropriately interrupting the transmission of power even when a structure that interrupts the transmission of power when in two-wheel drive is simple and compact.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a block diagram schematically showing a four-wheel drive vehicle according to an example embodiment of the invention;

FIG. 2 is a partial sectional view of a two-way clutch according to the example embodiment of the invention;

FIG. 3 is a view illustrating the operation of the two-way clutch according to the example embodiment of the invention, with FIG. 3A being a view showing an interrupted state, FIG. 3B being a view showing a forward drive state, and FIG. 3C being a view showing a reverse drive state;

FIG. 4 is a view schematically showing a connecting structure of the two-way clutch, and a rear drive gear and a differential case according to the example embodiment of the invention;

FIG. 5 is a block diagram schematically showing a modified example of the four-wheel drive vehicle according to the example embodiment of the invention;

FIG. 6 is a block diagram schematically showing another modified example of the four-wheel drive vehicle according to the example embodiment of the invention; and FIG. 7 is a view schematically showing a modified example of the connecting structure of the two-way clutch, and the rear drive gear and the differential case.

### DETAILED DESCRIPTION OF EMBODIMENTS

Hereinafter, a four-wheel drive vehicle according to example embodiments of the invention will be described with reference to the accompanying drawings.

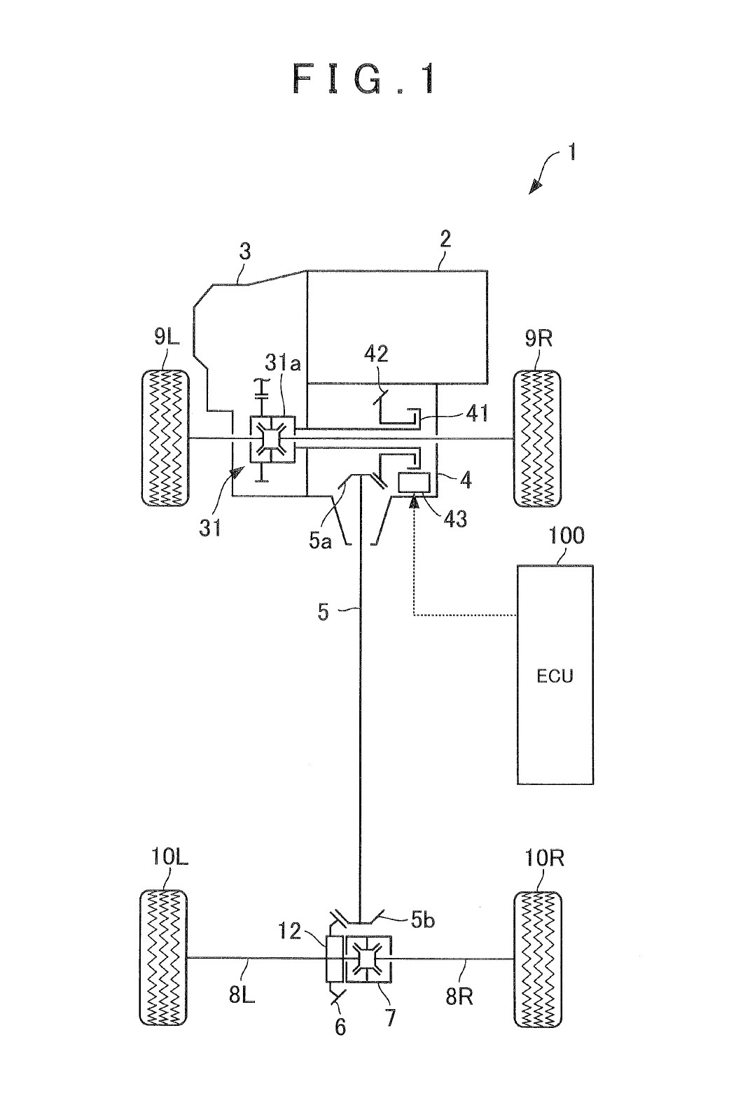

As shown in FIG. 1, a four-wheel drive vehicle 1 is a four-wheel drive vehicle that is based on a front-engine front-drive type vehicle, and is capable of switching between front wheel two-wheel drive and four-wheel drive according to the running state. The four-wheel drive vehicle 1 includes an engine 2 that serves as a driving force source, a transaxle 3, a transfer 4, a propeller shaft 5, a rear drive gear 6, a rear differential gear 7, a pair of left and right front wheels 9L and 9R, a pair of left and right rear wheels 10L and 10R, and a two-way clutch 12.

The four-wheel drive vehicle 1 also includes an ECU (Electronic Control Unit) 100 as a vehicle electronic control unit for controlling the entire four-wheel drive vehicle 1. The driving force source is not limited to an internal combustion engine such as the engine 2, and may also be an electric motor, or an electric motor used in combination with an internal combustion engine.

The transaxle 3 includes a front differential 31 that has a differential case 31a, and a transmission, not shown. The front differential 31 is connected to the engine 2 via the transmission, not shown, and is also connected to the front wheels 9L and 9R and the transfer 4.

The transaxle 3 changes the rotation speed and power (hereinafter referred to as “torque”) generated by the engine 2, based on a speed ratio according to the running state of the four-wheel drive vehicle 1. The rotation speed and torque of the engine 2 that have been changed by the transaxle 3 are then transmitted to the front wheels 9L and 9R and the transfer 4 via the front differential 31.

The front wheels 9L and 9R are connected to the front differential 31 and form main driving wheels to which the torque of the engine 2 is normally transmitted.

The front wheels 9L and 9R are driven by torque transmitted from the engine 2 via the front differential 31.

The transfer 4 includes an output member 41 that is connected to the differential case 31a in a manner so as to be able to rotate together with the differential case 31a, a transfer ring gear 42 that is connected to the output member 41, and a switching device 43 that switches a connection state between the output member 41 and the transfer ring gear 42.

The transfer ring gear 42 is in mesh with a hypoid gear 5a of the propeller shaft 5. The output member 41 is connected to the engine 2 via the front differential 31.

The switching device 43 is a two-wheel drive/four-wheel drive switching mechanism configured to be able to switch between a four-wheel drive state in which torque is transmitted from the engine 2 to the propeller shaft 5, and a two-wheel drive state in which this transmission of torque is interrupted.

A control clutch such as a wet type multiple disc clutch, for example, may be used as the switching device 43. In this example embodiment, a so-called electronically controlled coupling device capable of changing the torque transmitted between the output member 41 and the transfer ring gear 42 by electronic control is used as the switching device 43.

The switching device 43 switches the connection state between the output member 41 and the transfer ring gear 42, so as to switch between the four-wheel drive state and the two-wheel drive state, by driving an actuator in response to a command signal from the ECU 100. The switching device 43 in this example embodiment can be regarded as an example of the switching mechanism of the invention.

The transfer 4 structured in this way changes the torque output from the transaxle 3 at a right angle, and transmits it to the propeller shaft 5.

The propeller shaft 5 is configured as a power transmitting shaft that transmits the torque of the engine 2 to the rear wheels 10L and 10R. The propeller shaft 5 includes the hypoid gear 5a fixed to a front end portion and a drive pinion gear 5b fixed to a rear end portion. The drive pinion gear 5b is in mesh with the rear drive gear 6.

The rear wheels 10L and 10R are driven wheels that are connected to the rear drive gear 6, and to which the torque of the engine 2 is transmitted according to the running state of the four-wheel drive vehicle 1. The torque transmitted from the transfer 4 to the propeller shaft 5 is transmitted to the rear wheels 10L and 10R via the rear drive gear 6 and the rear differential gear 7.

The rear drive gear 6 is formed by a ring gear and is provided between the propeller shaft 5 and the rear differential gear 7. The rear drive gear 6 is in mesh with the drive pinion gear 5b.

The rear differential gear 7 is connected to drive shafts 8L and 8R of the rear wheels 10L and 10R. Also, the rear differential gear 7 is connected to the rear drive gear 6 via the two-way clutch 12. The rear differential gear 7 in this example embodiment can be regarded as an example of a differential gear of the invention, and the drive shafts 8L and 8R can be regarded as an example of an axle of the invention.

The two-way clutch 12 is provided between the rear drive gear 6 and the rear differential gear 7. The two-way clutch 12 is configured to be able to switch between a transmitting state in which torque is transmitted between the propeller shaft 5 and the rear wheels 10L and 10R, and an interrupted state in which the transmission of torque is interrupted. The two-way clutch 12 in this example embodiment can be regarded as an example of a connecting/interrupting mechanism of the invention. This two-way clutch 12 will be described in detail later.

The ECU 100 includes a CPU (Central Processing Unit), ROM (Read Only Memory) that stores fixed data, RAM (Random Access Memory) that temporarily stores data, EEPROM (registered trademark: Electrically Erasable and Programmable Read Only Memory) formed of rewritable non-volatile memory, and an input/output interface circuit (I/F). This ECU 100 comprehensively controls the four-wheel drive vehicle 1.

The ECU 100 is connected to the switching device 43, and drives the actuator of the switching device 43 based on information input from various sensors that detect the running state of the four-wheel drive vehicle 1.

For example, when it is determined that four-wheel drive running is necessary based on the detection results from the various sensors, such as when acceleration is required while traveling straight, or when taking off, the ECU 100 drives the actuator so as to place the switching device 43 in the four-wheel drive state.

On the other hand, when it is determined that four-wheel drive running is not necessary based on the detection results of the various sensors, such as when traveling at a steady speed while driving through urban areas or the like, or when taking off with relatively small acceleration (i.e., when taking off with slow acceleration), the ECU 100 stops driving the actuator so as to place the switching device 43 in the two-wheel drive state.

A switching switch or a switching lever or the like with which the driver is able to appropriately select two-wheel drive running and four-wheel drive running may be provided, and the ECU 100 may drive the actuator of the switching device 43 based on an input signal from these.

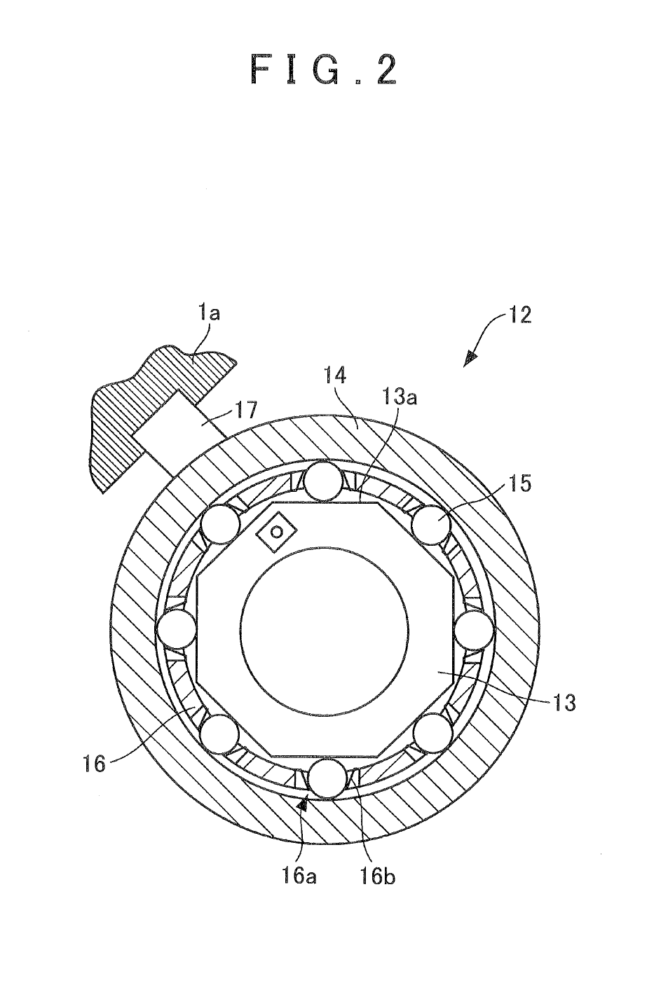

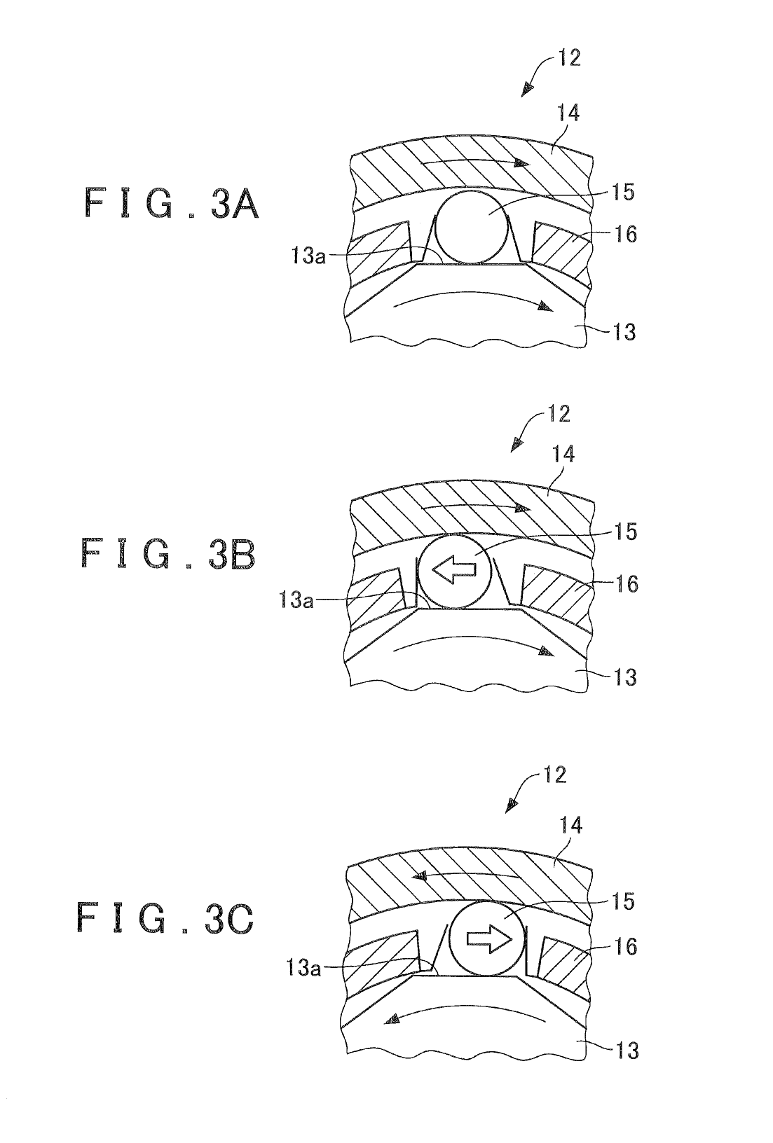

Next, the detailed structure and operation of the two-way clutch 12 will be described with reference to FIGS. 2 and 3.

As shown in FIG. 2, the two-way clutch 12 is a simple mechanical two-way clutch configured to be able to switch between rotating idly or driving in both the forward and reverse directions, and is able to select any one of three states, i.e., an interrupted state, a forward driving state, and a reverse driving state. This two-way clutch 12 has a large torque capacity, is compact in size, and also does not require special control.

The two-way clutch 12 includes an inner race 13, an outer race 14, rollers 15, a retainer 16, and a switching plate 17.

The inner race 13 is connected to the rear drive gear 6 (see FIG. 1), and a plurality of cam surfaces 13a are formed on an outer peripheral surface thereof. The outer race 14 is arranged radially outward of the inner race 13, and is connected to a differential case 7a (see FIG. 1) of the rear differential gear 7. The plurality of rollers 15 are provided in the circumferential direction between the inner race 13 and the outer race 14.

The retainer 16 retains the plurality of rollers 15 at equidistant intervals in the circumferential direction. More specifically, the retainer 16 retains each of the rollers 15 in a retainer pocket 16a by a plate spring 16b provided in the retainer pocket 16a.

The switching plate 17 is fixed at one end to a stationary member 1a provided on the vehicle main body. Also, the switching plate 17 is pushed against the retainer 16 by a wave spring, not shown. Therefore, the switching plate 17 applies resistance to the retainer 16 in the direction opposite the rotational direction of the inner race 13. A differential carrier that houses the rear differential gear 7, or the like, is one example of the stationary member 1a.

As shown in FIG. 3A, with the two-way clutch 12, each roller 15 is retained in the center, in the circumferential direction, of the corresponding cam surface 13a by the plate spring 16b when rotation is not applied to the inner race 13.

At this time, the roller 15 does not contact the outer race 14 because the diameter of the roller 15 is smaller than the interval between the center of the cam surface 13a in the circumferential direction and the inner peripheral surface of the outer race 14. Therefore, the two-way clutch 12 is placed in an interrupted state in which the inner race 13 and the outer race 14 rotate (rotate idly) independently, so torque is not transmitted between the inner race 13 and the outer race 14.

Meanwhile, as shown in FIG. 3B, with the two-way clutch 12, when rotation is applied to the inner race 13, a phase difference occurs between the inner race 13 and the retainer 16, so the roller 15 moves into one of the wedges formed by both circumferential end portions of the cam surface 13a and the inner peripheral surface of the outer race 14.

At this time, if the rotation speed Ni of the inner race 13 is faster than the rotation speed No of the outer race 14 (i.e., Ni>No), the roller 15 will become lodged (i.e., wedged) in the wedge, thus enabling torque to be transmitted between the inner race 13 and the outer race 14. When the four-wheel drive vehicle 1 is running in reverse, the roller 15 moves in the opposite direction and wedges into the other wedge, as shown in FIG. 3C, thus similarly enabling torque to be transmitted between the inner race 13 and the outer race 14.

Also, with the two-way clutch 12, when the rotation speed Ni of the inner race 13 is slower than the rotation speed No of the outer race 14 (i.e., Ni<No) in the states shown in FIGS. 3B and 3C, i.e., in a transmitting state, the roller 15 dislodges from the wedge and comes to be in the state shown in FIG. 3A, such that the inner race 13 and the outer race 14 rotate (rotate idly) independently, i.e., the two-way clutch 12 is placed in the interrupted state.

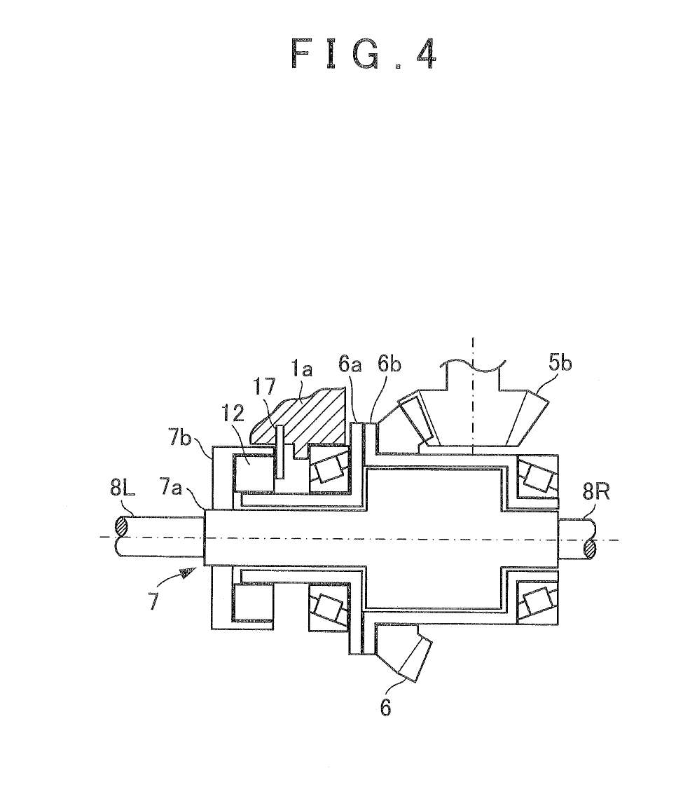

Next, the connecting structure of the two-way clutch 12, and the rear drive gear 6 and the differential case 7a will be described with reference to FIG. 4.

As shown in FIG. 4, with the two-way clutch 12, the outer race 14 (see FIG. 2) is integrally fixed to the differential case 7a via a connecting member 7b. Also, the inner race 13 (see FIG. 2) is integrally fixed to the rear drive gear 6 via connecting members 6a and 6b. The connecting member 6a and the connecting member 6b are connected together at a flange portion. Also, the connecting members 6a and 6b are supported by a pair of bearings on both sides of the rear drive gear 6 (i.e., sandwiching the rear drive gear 6). Therefore, even with a structure in which the two-way clutch 12 is provided between the rear drive gear 6 and the rear differential gear 7, the rear drive gear 6 is able to be stably supported. The connecting member 6a and the connecting member 6b are separate bodies, but they may also be integrated.

In this way, with the two-way clutch 12 according to this example embodiment, the outer race 14 (see FIG. 2) is fixed to the differential case 7a, and the inner race 13 (see FIG. 2) is fixed to the rear drive gear 6, so the outer race 14 rotates together with the differential case 7a, and the inner race 13 rotates together with the rear drive gear 6.

Next, the operation of the two-way clutch 12 according to this example embodiment will be described.

First, when the four-wheel drive vehicle 1 is in the four-wheel drive state, the rotation speed of the inner race 13 is faster than the rotation speed of the outer race 14 (i.e., Ni>No) due to the rotation of the propeller shaft 5. Therefore, as shown in FIG. 3B, the two-way clutch 12 is placed in the transmitting state in which the roller 15 is lodged (i.e., wedged) in the wedge, and torque is transmitted from the inner race 13 to the outer race 14. That is, the rotation of the propeller shaft 5 is transmitted to the rear wheels 10L and 10R and the four-wheel drive state is maintained. The differential gear ratio and the gear ratio between the drive pinion gear 5b and the rear drive gear 6 and the like are set to appropriate maximum values such that the rotation speed of the rear drive gear 6 will be faster than the rotation speed of the differential case 7a in the four-wheel drive state. As a result, the state in which Ni is greater than No (i.e., Ni>No) is maintained in the four-wheel drive state.

Continuing on, when the connection state between the output member 41 and the transfer ring gear 42 is made a disengaged state by the switching device 43, such that the two-wheel drive state is established, the transmission of power between the output member 41 and the transfer ring gear 42 is interrupted, so the rotation speed of the propeller shaft 5 that had been rotating up until this point decreases.

As a result, as the rotation speed of the propeller shaft 5 decreases, the rotation speed of the inner race 13 becomes slower than the rotation speed of the outer race 14 (i.e., Ni<No). Therefore, the two-way clutch 12 shifts to the interrupted state in which the roller 15 is dislodged from the wedge. That is, the propeller shaft 5 is disconnected from the rear wheels 10L and 10R. Therefore, the propeller shaft 5 stops rotating because it is completely disconnected from both the rear wheels 10L and 10R and the engine 2 side.

In this way, in this example embodiment, operation of the two-way clutch 12 enables rotation of the propeller shaft 5 to be stopped in the two-wheel drive state simply by switching the switching device 43 to the interrupted state. Stopping the rotation of the propeller shaft 5 when in two-wheel drive enables fuel efficiency to be improved.

As described above, in the four-wheel drive vehicle 1 according to this example embodiment, the two-way clutch 12 that is capable of automatically switching between the interrupted state and the transmitting state according to a difference in rotation speed between the inner race 13 and the outer race 14 is used as means for stopping a rotating element such as the propeller shaft 5 when in two-wheel drive, so the structure for interrupting the transmission of power when in two-wheel drive is able to be simple and compact.

Also, with the four-wheel drive vehicle 1 according to this example embodiment, the two-way clutch 12 is provided between the rear drive gear 6 and the rear differential gear 7, so the transmission of power is able to be more appropriately interrupted, without reverse rotation from the rear differential gear 7 being input to the two-way clutch 12 when the transmission of power is interrupted, compared to when the two-way clutch 12 is provided on the drive shaft.

Also, the four-wheel drive vehicle 1 is not a structure in which a conventional control clutch that is associated with slippage is provided on the drive shaft, so a problem such as a change in the front-rear torque distribution amount according to a torque bias ratio (TBR) of the rear differential gear that occurs when a control clutch is provided on the drive shaft will not occur.

In this example embodiment, an example is described in which the two-way clutch 12 is used as the connecting/disconnecting mechanism of the invention, but the invention is not limited to this. For example, a sprag-type or cam-type one-way clutch or the like may also be used as a portion of the connecting/disconnecting mechanism.

Also, in this example embodiment, a simple mechanical two-way clutch is used as the two-way clutch 12, but the invention is not limited to this. For example, a two-way clutch in which a mechanical roller clutch has been combined with an electromagnet may also be used. In this case, the switch between the driving state and the idly rotating state is able to be controlled by controlling the electromagnet ON and OFF with the ECU 100.

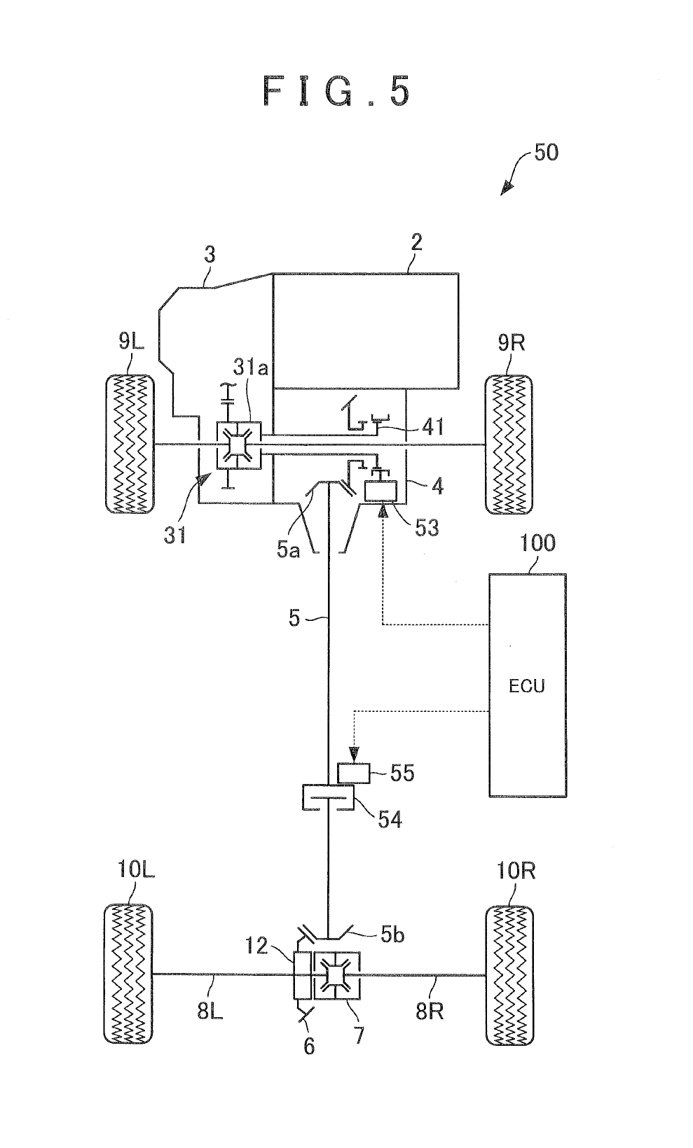

Also, in this example embodiment, an example is described in which the invention is applied to the four-wheel drive vehicle 1 that uses the switching device 43 formed by an electronically controlled coupling device as the two-wheel drive/four-wheel drive switching mechanism, but the invention is not limited to this. For example, the invention may also be applied to a four-wheel drive vehicle 50 that includes a switching device 53 formed by a synchronizer mechanism as the two-wheel drive/four-wheel drive switching mechanism, as shown in FIG. 5.

In this case, a switch is made between the two-wheel drive state and the four-wheel drive state by a sleeve being moved by the driving of an actuator in response to a command signal from the ECU 100. Also, in this four-wheel drive vehicle 50, a control clutch 54 is provided on the propeller shaft 5. An electronically controlled coupling device capable of adjusting the amount of torque distributed to the rear wheels 10L and 10R by the driving of an electromagnetic actuator 55 in response to a command signal from the ECU 100 may be used as the control clutch 54.

This kind of structure of the four-wheel drive vehicle 50 is useful when there is no space to mount a control clutch in the transfer 4.

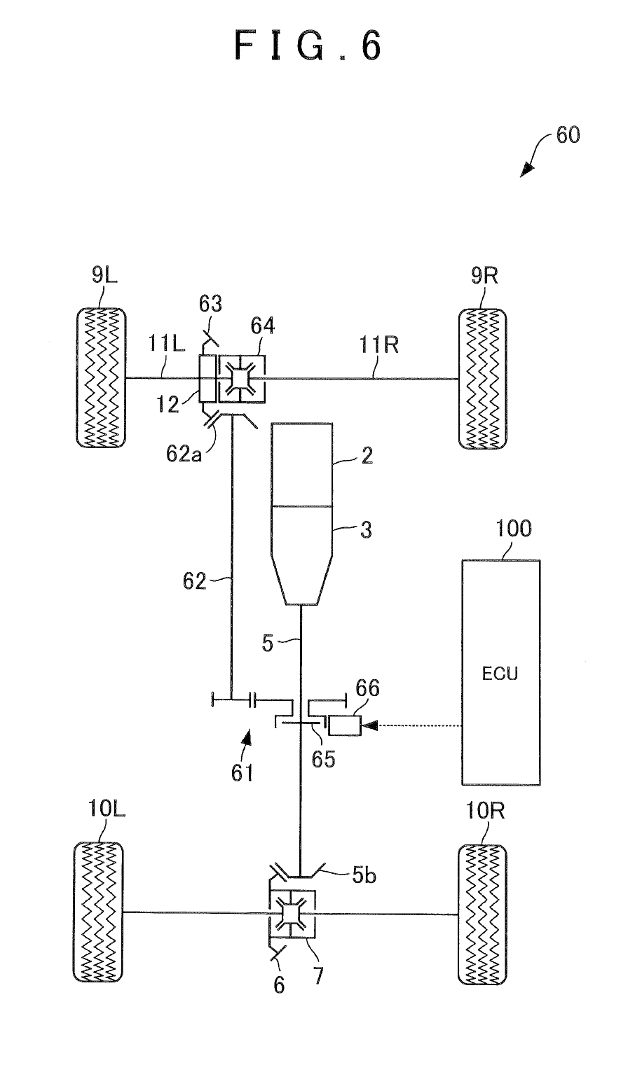

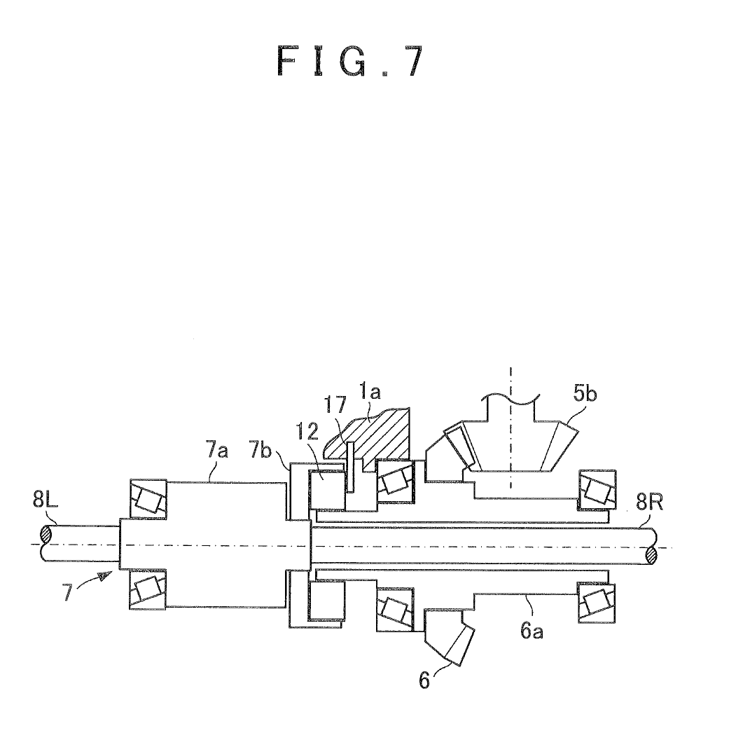

Also, in this example embodiment, an example is described in which the invention is applied to a front-engine front-drive type four-wheel drive vehicle 1, but the invention is not limited to this. For example, the invention may also be applied to a front-engine rear-drive type four-wheel drive vehicle 60 such as that shown in FIG. 6.

As shown in FIG. 6, with the four-wheel drive vehicle 60, rotation of the propeller shaft 5 is transmitted to a front propeller shaft 62 via a transmitting mechanism 61. The rotation transmitted to the front propeller shaft 62 is transmitted from a hypoid gear 62a to the front wheels 9L and 9R via a front drive gear (a ring gear) 63, a front differential gear 64, and drive shafts 11L and 11R. Also, a control clutch 65 is provided as a two-wheel drive/four-wheel drive switching mechanism on the transmitting mechanism 61. An electronically controlled coupling device capable of adjusting the amount of torque distributed to the front wheels 9L and 9R by the driving of an electromagnetic actuator 66 in response to a command signal from the ECU 100 may be used as the control clutch 65. In the four-wheel drive vehicle 60, the front wheels 9L and 9R form driven wheels and the rear wheels 10L and 10R form main driving wheels.

Also, in the four-wheel drive vehicle 60 shown in FIG. 6, the two-way clutch 12 is provided between the front drive gear 63 and the front differential gear 64. The connecting structure and the structure of the two-way clutch 12 and the like are the same as they are in the example embodiment, so descriptions thereof will be omitted.

Also, with the four-wheel drive vehicle 60, there may be times that the rotation on the front differential gear 64 side is faster than the rotation on the front drive gear 63 side due to operation of the front propeller shaft 62 that is driven in conjunction with the rear wheel 10L and 10R side that has a smaller turning radius when turning in the four-wheel drive state. In this case, there is a possibility of a problem occurring in which toque is not able to be transmitted from the front drive gear 63 to the front differential gear 64 due to the operation of the two-way clutch 12. Therefore, with the four-wheel drive vehicle 60, in order to eliminate this problem, the gear ratio of the hypoid gear 62a is made smaller than the gear ratio of the drive pinion gear 5b. As a result, the rotation of the front drive gear 63 becomes faster, and torque is able to be transmitted to the front differential gear 64.

Also, in the example embodiment and the modified example described above, an example is described in which an electronically controlled coupling is employed as the control clutch, but as long as the control clutch is able to be electronically controlled by the ECU, the control clutch may have any of a variety of structures. For example, the control clutch may apply pressing torque using an actuator such as an electric motor, or the control clutch may apply pressing torque by an electromagnet or hydraulic pressure.

Also, in this example embodiment, the two-way clutch 12, and the rear drive gear 6 and the differential case 7a are connected by the structure shown in FIG. 4, but the invention is not limited to this. For example, a connecting structure such as that shown in FIG. 7 may also be employed.

That is, as shown in FIG. 7, the differential case 7a is provided separated from the area near the rear drive gear 6 by predetermined distance on the rear wheel 10L side in the axial direction of the drive shafts 8L and 8R. Also, the outer race 14 (see FIG. 2) is integrally fixed to the differential case 7a via the connecting member 7b, just as in the example embodiment. Also, the inner race 13 (see FIG. 2) is integrally fixed to the rear drive gear 6 via the connecting member 6a. The connecting member 6a differs from that of the example embodiment in that it is formed by a single member. It goes without saying that the connecting member 6a may also be formed by a plurality of members, as it is in the example embodiment.

As described above, the four-wheel drive vehicle according to the invention is useful as a four-wheel drive vehicle that is able to appropriately interrupt the transmission of power, even when the structure for interrupting the transmission of power when in two-wheel drive is made simple and compact, and that is able to switch between two-wheel drive and four-wheel drive according to the running state of the vehicle.

What is claimed is:

1. A four-wheel drive vehicle comprising:
a pair of main driving wheels to which power of a driving force source is transmitted;
a pair of driven wheels to which power of the driving force source is transmitted according to a running state of the four-wheel drive vehicle;
a power transmitting shaft configured to transmit the power of the driving force source to the driven wheels;
a differential gear connected to an axle of the driven wheels;
a ring gear provided between the power transmitting shaft and the differential gear;
a switching mechanism configured to switch between a four-wheel drive state and a two-wheel drive state, power being transmitted from the driving force source to the power transmitting shaft in the four-wheel drive state, and transmission of the power from the driving force source to the power transmitting shaft being interrupted in the two-wheel drive state; and
a two-way clutch provided between the ring gear and the differential gear, the two-way clutch switching between a transmitting state and an interrupted state, power being transmitted between the power transmitting shaft and the driven wheels in the transmitting state, and transmission of the power between the power transmitting shaft and the driven wheels being interrupted in the interrupted state.

2. The four-wheel drive vehicle according to claim 1, wherein
the main driving wheels are rear wheels;
the driven wheels are front wheels; and
a gear ratio of a gear of the power transmitting shaft that is in mesh with the ring gear is smaller than a gear ratio of a gear provided on a rear wheel-side end of the power transmitting shaft.
